(19) United States
(12) Patent Application Publication
(10) Pub. No.: US 2026/0131290 A1
(43) Pub. Date: May 14, 2026

(54) MANTLE, COVER OR SHEET FOR THE DISTRIBUTION AND/OR EXTRACTION OF A FLOW TO AND/OR FROM A LEACHING PILE

(71) Applicant: WATER SAVE TECHNOLOGY SpA, Santiago (CL)

(72) Inventor: Alexis ARANCIBIA REYES, Santiago (CL)

(21) Appl. No.: 19/115,447

(22) PCT Filed: Sep. 25, 2023
(86) PCT No.: PCT/IB2023/020062

§ 371 Date: Mar. 26, 2025

(30) Foreign Application Priority Data
Sep. 26, 2022 (CL) 2618-2022

(51) Int. Cl. B01D 69/12; B01D 11/02; C22B 3/04

(52) U.S. Cl. CPC B01D 69/12; B01D 11/0219; C22B 3/04

(57) ABSTRACT

The present invention relates to a mantle, cover or sheet (1, 1′) for the distribution and/or extraction of a flow to and/or from a leaching pile that is covering, whose configuration allows maintaining a constant and uniform distribution and/or extraction of flow, comprises at least one film or sheet (2), and at least one irrigation line of solutions or fluids attached, joined and/or fixed to a surface of the film or sheet (2), where the irrigation line is at least one double irrigation line (9) that comprises at least two irrigation pipes (10, 10′), where each of said irrigation pipes (10, 10′) comprises at least one irrigation means, and where it also comprises at least one double feed line (11) of fluids or solutions, which comprises two feed pipes (12, 12′), comprising valves and independent flow control means.

### FIELD OF THE INVENTION

The present invention is framed in the field of mining, as well as agriculture, waste treatment, among others, areas of the industry in which it is necessary to cover a surface while conducting and/or extracting a fluid flow. Preferably, the present invention is framed in mining activity, specifically those activities or procedures related to the extraction of minerals by solvents, such as heap leaching, and corresponds to a sheet, film, mantle or cover to which at least one distribution and/or extraction line of a flow, whether liquid or gaseous, such as a solution, water, air, gas, among others, is attached, whose configuration and shape allow for the safe and constant maintenance of the distribution and/or extraction.

### BACKGROUND OF THE INVENTION

In the field of mining, one of the processes for obtaining minerals corresponds to the leaching process, where the procedure normally considers the formation of leaching heaps of mineral coming from the mine, which is reduced to a pre-established granulation that extends over an impermeable base or surface that receives the leachate from the heap. Once the heap has been prepared, the target metal is leached by circulating a leaching solution through the heap, in a procedure commonly known as percolation. To carry out percolation, the leaching solution is distributed over the top of the heap, allowing it to infiltrate down through the heap onto the impermeable surface.

There are several known options for distributing the leaching solution on the upper surface of a heap. The options that are generally used correspond to spraying systems or spraying the solution over the upper surface of the heap or drip systems, which is achieved by mounting a drip mesh over the surface of the heap to be leached.

The application dose of leaching solutions is designed to optimize metal recovery and minimize chemical consumption, where the critical factors influencing achieving this relationship correspond to the design of the heap, the irrigation system, and the climatic conditions of the site where the heap is formed. The uniformity of distribution of the solution is essential to maximize metal recovery.

The heap leaching procedure has the advantage of allowing the treatment of a large amount of low-grade mineral at a low cost; however, it also has a number of disadvantages, as the irrigation system used considers the use of a hose mesh that has drippers or sprinklers located at a predetermined distance, where this irrigation pipe mesh is arranged over the upper surface of the heap to be leached, exposing the irrigation to the climatic conditions of the area where the heap is designed, meaning that the leaching solution as well as the heap being irrigated are subject to losses due to evaporation and losses due to wind action, among other factors that affect the leaching process. The droplets of leaching solution are carried away by the wind near the leaching heap, which can contaminate the environment with toxic elements, and additionally, due to the action of the wind and the evaporation to which the leaching heap is subjected, being directly exposed to the environment, produces high evaporation rates, which implies a large amount of water used to carry out the leaching process, leading to increased production costs as well as harm to the environment.

Another important factor to consider is that evaporation causes heat loss, which lowers the temperature of the leaching solution, reducing the reaction rate of the chemical leaching. The leaching solution, when exposed over a large surface to sunlight, increases the potential for photochemical degradation of photosensitive leaching compounds, which leads to decreased leaching results.

During the leaching process, a series of gases are produced as a result of the chemical reaction between the mineral and the leaching solution being sprayed on the mineral heap, such as nitric acid gases; however, currently, these gases are not recovered, which causes environmental pollution and creates a contaminating environment in the leaching heap, which conditions an unsafe working environment for personnel on the heap.

Currently, films or covers for the surface to be leached have been used that are placed over the irrigation mesh, to cover the upper surface of the leaching heap with this cover and thus prevent the evaporation of the leaching solution, as well as increase the temperature of the leaching heap, enhancing the conditions for the proliferation of bacteria in bio-leaching procedures. Notwithstanding the above, these solutions have produced a significant advantage in managing the evaporation parameters of the leaching solution, reducing the rate of water and leaching agent usage, as well as increasing the temperature of the leaching heap, the operation of placing these films over the upper surface of the leaching heap involves the use of a large amount of labor, as well as the time required for their placement and fixing, so that the film or covers of the surface of the leaching heap are not affected or blown away by the wind.

Leaching heaps can be large and extensive, requiring a large amount of qualified personnel to monitor and control the leaching process; however, today in the art, a series of systems and procedures have been developed that allow monitoring the irrigation rate, saturation zones, fluid flow in the irrigation mesh, humidity, evaporation, and temperature of the leaching heap. However, these systems consider the use of a series of devices, sensors, cameras, among other equipment, that must be placed throughout the large surface area of a leaching heap, which leads to a large amount of qualified labor to equip a leaching heap with an automated monitoring and control system.

Today, there are several solutions in the industry where the cover, sheet, or film has been attached, joined, or fixed to the distribution lines of the leaching solution, which has been a notable advancement in the industry, as it facilitates the arrangement of the irrigation mesh and the cover of the heap. Notwithstanding the above, each of the drippers or means of distributing the leaching solution that comprise the irrigation mesh typically suffer from clogging due to sediments present in the irrigation solutions as well as the environment to which they are exposed, which prevents achieving the desired recovery since the area under the dripper or distribution means stops irrigating and therefore is no longer available for extraction.

Therefore, there is a need in the art to have a layer, cover, mat, sheet, and/or film, whose configuration includes in an integrated manner, either in an attached, joined, or fixed form, the irrigation lines of the solution or fluid in a single piece, and whose configuration allows for uniform irrigation over time, regardless of whether any irrigation line becomes obstructed or clogged, as well as its configuration being versatile enough to allow for the extraction of gases produced in the leaching process, in such a way as to avoid contamination and exposure of personnel to such gases that may be harmful.

### SUMMARY OF THE INVENTION

The primary object of the invention is to provide an element that allows covering a surface that has at least one integrated distribution and/or extraction line of a double flow, whether for the irrigation of a leaching solution and/or the extraction of a gas, which allows maintaining the uniformity of irrigation and/or gas extraction over time on a leaching heap regardless of whether at least another distribution and/or extraction line is obstructed or clogged.

Another objective of the invention is to provide a cover to cover a surface whose configuration comprises a thermoplastic film that can be deployed quickly and efficiently to cover a surface, and that at the same time allows the deployment of the mesh of double distribution and/or extraction lines of flows of solutions and/or gases.

The present invention relates to a mantle, cover, or sheet (1, 1′) for the distribution and/or extraction of a flow to and/or from a leaching pile that it covers, whose configuration allows for the constant and uniform maintenance of the distribution and/or extraction of flow, comprising at least one film or sheet (2), and at least one irrigation or watering line of solutions or fluids attached, joined, and/or fixed to a surface of the film or sheet (2), where the irrigation or watering line is at least one double irrigation or watering line (9) that comprises at least two irrigation pipes (10, 10′), where each of said irrigation pipes (10, 10′) comprises at least one irrigation means, and where it also comprises at least one double supply line (11) of fluids or solutions, which comprises two supply pipes (12, 12′), which comprise valves and independent flow control means, and where said supply pipes (12, 12′) feed the solutions or fluids to the at least one double irrigation or watering line (9), such that the first irrigation pipe (10) is connected to the first supply pipe (12), and the second irrigation pipe (10′) is connected to the second supply pipe (12).

### DETAILED DESCRIPTION OF THE INVENTION

Various non-limiting embodiments of the present invention will now be described to provide a general understanding of the principles of structural function, manufacturing, and use of the devices, methods, and articles described in this description. One or more examples of these non-limiting embodiments are illustrated in the attached figures. Those skilled in the art would understand that the devices and methods specifically described in this description and illustrated in the attached figures are illustrative non-limiting embodiments and that the scope of the various non-limiting embodiments of the present invention is defined solely by the claims. The features illustrated or described in conjunction with a non-limiting embodiment may be combined with the features of other non-limiting embodiments. Such modifications and variations are intended to be included within the scope of the present invention.

### DESCRIPTION OF THE DRAWINGS

To assist in a better understanding of the characteristics of the invention, according to a preferred example of its practical implementation, a set of drawings is included as an integral part of the description, where the invention is represented illustratively and not restrictively.

FIG. 1.—corresponds to a perspective view of a mantle, cover, or sheet for the distribution and/or extraction of a flow to and/or from a leaching pile of the present invention.

FIG. 2.—corresponds to a top perspective view of the mantle, cover, or sheet for the distribution and/or extraction of a flow to and/or from a leaching pile of the present invention.

FIG. 3.—corresponds to a bottom perspective view of the mantle, cover, or sheet (1, 1′) for the distribution and/or extraction of a flow to and/or from a leaching pile of the present invention.

FIG. 4.—corresponds to a bottom perspective view of an enlargement of a part of the mantle, cover, or sheet for the distribution and/or extraction of a flow to and/or from a leaching pile of the present invention.

FIG. 5.—corresponds to a bottom plan view of the mantle, cover, or sheet for the distribution and/or extraction of a flow to and/or from a leaching pile of the present invention.

FIG. 6.—corresponds to a top perspective view of a second embodiment of the mantle, cover, or sheet for the distribution and/or extraction of a flow to and/or from a leaching pile according to the present invention.

FIG. 7.—corresponds to a top perspective view of a variation of the second embodiment of the mantle, cover, or sheet for the distribution and/or extraction of a flow to and/or from a leaching pile according to the present invention.

### PREFERRED EMBODIMENT OF THE INVENTION

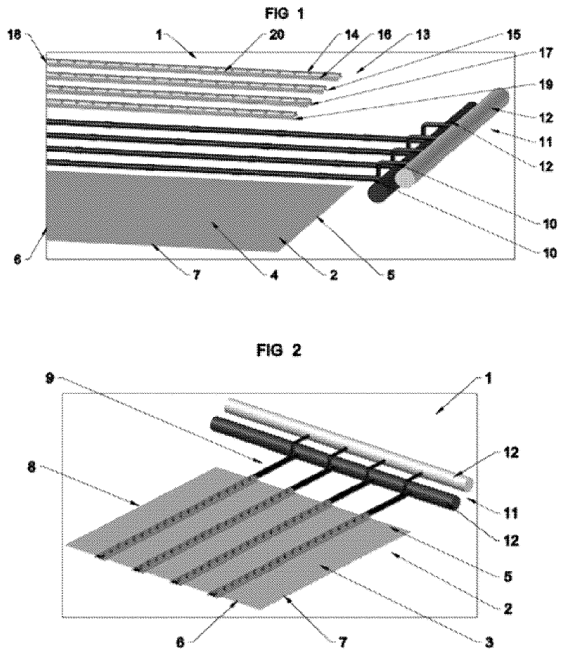

The invention corresponds to a mantle, cover, or sheet (1, 1′) for the distribution and/or extraction of a flow to and/or from a leaching pile that it covers, which can be observed in FIGS. 1 to 6, which in one embodiment of the invention, as illustrated in FIGS. 1 to 5, comprises a film or sheet (2) that has an upper surface (3) and a lower surface (4) that define an area circumscribed by opposite end edges (5, 6) and opposite side edges (7, 8), configuring a coverage area defined by the film or sheet (2) that comprises different shapes, dimensions, and sizes. The lower surface (4) of the film (2) is the surface that faces the surface to be covered or on which the mantle, cover, or sheet (1) of irrigation will be placed. At least one double irrigation or watering line (9) of solutions or fluids is attached, joined, and/or fixed to the lower surface (4) of the film or sheet (2), in a preferred embodiment; however, this double irrigation or watering line (9), as can be well understood by a person skilled in the art, may be attached and/or fixed to the upper surface (3) of the film or sheet (2).

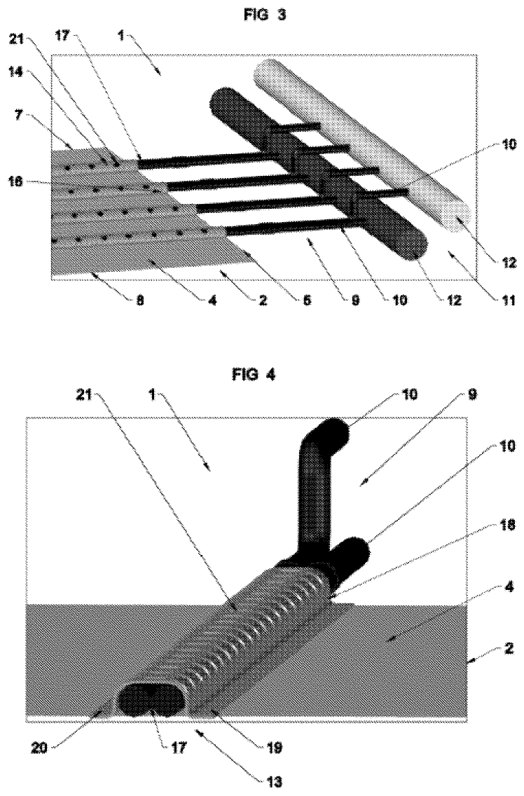

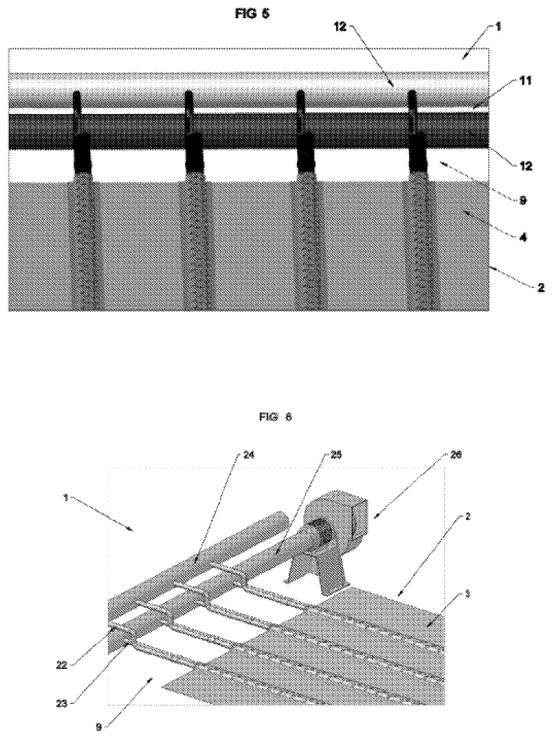

The double irrigation or watering line (9) comprises at least two irrigation pipes (10, 10′), as shown in more detail in FIGS. 3 and 4, where each of said irrigation pipes (10, 10′) comprises at least one irrigation means, where said irrigation means is arranged in a spaced distribution along the irrigation pipe (10, 10′), where said irrigation means may comprise a sprinkler, a dripper, a micro-sprinkler, or any other means of distributing fluids, water, solutions, among others.

The mantle, cover, or sheet (1, 1′) for the distribution and/or extraction of a flow to and/or from a leaching pile also comprises at least one double supply line (11) of fluids or solutions, which comprises two supply pipes (12, 12′), which comprise valves and independent flow control means, and where said supply pipes (12, 12′) feed the solutions or fluids to the at least one double irrigation or watering line (9), such that the first irrigation pipe (10) is connected to the first supply pipe (12), and the second irrigation pipe (10′) is connected to the second supply pipe (12).

In a preferred embodiment of the invention, the double irrigation line (9) is attached, joined, and/or fixed to at least one surface (3, 4) of the film or sheet (2) by at least one fixing and/or joining element (13), which is configured as a strip, tape, and/or band (14) of a sheet or film, which comprises a defined upper and lower surface (15, 16) defined by opposite end edges (17, 18) and opposite side edges (19, 20), defining an area or surface of different dimensions. Said strip, band, and/or tape (14) comprises at least one perforation (21) that forms a tape with a predefined perforation pattern. Said at least one fixing and/or joining element (13), as seen in figure No. 4, allows joining the double irrigation or watering line (9) to at least one of the surfaces of the film (2), so that said irrigation or watering line (9) is arranged between said band, tape, and/or strip (13) and at least one surface of the film (2), such that lateral portions of said tape, band, and/or strip (13) are fixed to at least one surface of the film or sheet (2), so that the double irrigation or watering line (9) is placed in between, where the fixing of said lateral portions to the surface of the film or sheet (2) can be carried out by one of the techniques or procedures of plastic welding, and/or by one of the mechanical joining systems, as described above in the memory of the present application, or simply by gluing, stitching, or other joining and/or fixing system; however, preferably, the joining and/or fixing between the lateral portions of the tape, band, and/or strip (13) to the surface of the film or sheet (2) is carried out by thermal fusion. The material of the tape, band, and/or strip (13) may comprise a plastic, a thermoplastic, such as preferably a UV-resistant transparent polyethylene. The perforation pattern of the at least one perforation (21) that comprises said band, tape, and/or strip (13) achieves a homogeneous distribution of the fluid that exits and/or is delivered by said irrigation means (10), so that the perforation pattern of the holes allows for a homogeneous distribution of the fluid over the surface that is covered, as well as helps to prevent clogging of the irrigation means.

The mantle, cover, or sheet (1, 1′) for the distribution and/or extraction of a flow to and/or from a leaching pile may also comprise sensors that can measure temperature and/or humidity, among other parameters of the surface covered with the mantle. In one embodiment of the invention, the at least one sensor may comprise a sensor that allows measuring and/or monitoring temperature, humidity, airflow, luminosity, radiation, evaporation, surface saturation, aeration, among other parameters, as well as said sensors may comprise micro-cameras for capturing images, infrared images, among others. The sensors are connected to a monitoring, control, and/or autonomous remote transmission system that allows transmitting the different parameters that are recorded and/or monitored by the at least one sensor wirelessly to a main control center. Said transmission, monitoring, and/or control system is remote and autonomous, as it can be powered independently, anywhere a mantle, cover, or sheet (1, 1′) for the distribution and/or extraction of a flow to and/or from a leaching pile is used, where electrical energy is not available, as it comprises renewable electric generation devices, such as for example photovoltaic and/or wind energy.

Each of the double irrigation or watering lines may also be directly joined to at least one of the surfaces (3, 4) of the film or sheet (2), by different plastic welding techniques, such as by hot plate welding processes, hot air/gas welding, heat sealing, thermal fusion, extrusion welding, injection welding, ultrasonic welding, high-frequency welding, laser welding, vibration welding, as well as said irrigation or watering lines (9) may be joined to one of the surfaces of the film or sheet (2) by mechanical elements, such as by a double-sided adhesive tape, for example adhesive, velcro, among others, as well as through different solutions, such as glues. The material of the film or sheet (2) may comprise a plastic, a thermoplastic, such as preferably a UV-resistant transparent polyethylene, where additionally said film may comprise a padded plastic surface, in order to maintain the insulation of the covered surface. The materials, sizes, color, and/or thickness of the film or sheet (2) can be varied according to the particular requirement, such as they may comprise biodegradable materials, with multi-layer substrates, with different optical properties, with photo-selective materials, anti-static, and/or a combination of these, as well as they may incorporate insecticides, herbicides, anti-fungals, with antiviral properties, fertilizers among other solutions and/or a combination of these, as well as particles and/or nanoparticles of different materials and/or minerals, and/or a combination of these. The double irrigation or watering lines (9) may comprise different sizes, colors, resistance, materials, according to the type of flow that will be delivered, distributed, and/or removed from the surface, where said pipe may comprise perforations, micro-perforations, slots, where the materials may comprise PVC, Polyethylene, Plansa, rubber, among others, and/or a combination of these.

The mantle, cover, or sheet (1, 1′) for the distribution and/or extraction of a flow to and/or from a leaching pile may also comprise at least one geotextile, a geo net, a mulch joined and/or fixed to one of the upper and/or lower surfaces (3, 4) of the film or sheet (2), covering the entire extent, size, and/or shape of said mantle, cover, or sheet, as well as it may partially cover the extent of said cover. The configuration of said geotextile and/or geo net may comprise a biplanar and/or triplanar configuration, to facilitate the distribution of a flow, whether gas, air, water, and/or solutions, as well as the capture of said flow, through the covered surface.

The mantle, cover, or sheet (1, 1′) for the distribution and/or extraction of a flow to and/or from a leaching pile may also comprise at least one perforation made through the film or sheet (2), such that said perforation may coincide with an irrigation means of an irrigation or watering line (9), such that said perforation facilitates the planting of plants according to a predetermined pattern, for the purposes of using it as an element in plasticulture. Said perforation may comprise a pattern of die-cutting of the film layer, through micro-perforations, perforations, and/or punching, of the perimeter of the perforation, such that it allows the circumscribed portion of film or sheet (2) to be removed when its use is necessary, thus facilitating the formation of the perforation through the film (2), and preventing the film from tearing in an undesired pattern.

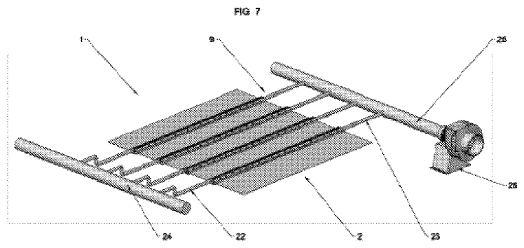

In a first embodiment of the mantle, cover or sheet (1, 1′) for the distribution and/or extraction of a flow to and/or from a leaching pile of the invention, as illustrated in FIG. 6, it is configured as at least one mantle, cover or sheet (1′) for the distribution and/or extraction of an irrigation flow and/or gases to and/or from a leaching pile, where the at least one double line (9′) that is attached and/or fixed to at least one surface (3, 4) of the film or sheet (2) is configured with at least one irrigation line (22) and/or with at least one gas extraction and/or distribution line (23), where said irrigation line (22) is connected to a leaching solution feed line (24) that comprises at least one feed pipe that conducts a fluid to said irrigation line (22), and where the at least one gas extraction and/or distribution line (23) is connected to a gas extraction and/or feed line (25) that at one of its ends is fixed to a gas extraction or injection means (26). With the configuration of the mantle, cover or sheet (1′) for the distribution and/or extraction of an irrigation flow and/or gases to and/or from a leaching pile, it is possible to irrigate a leaching solution in the pile while allowing the extraction of gases produced from the leaching process, thus avoiding environmental contamination and providing a contamination-free working environment for personnel.

As illustrated in FIG. 7, in one embodiment of the mantle, cover or sheet (1′) for the distribution and/or extraction of an irrigation flow and/or gases to and/or from a leaching pile, the leaching solution feed line (24) and the gas extraction and/or feed line (25) that at one of its ends is fixed to a gas extraction or injection means (26) are arranged or configured at opposite ends of the film or sheet (2).

The mantle, cover or sheet (1, 1′) for the distribution and/or extraction of a flow to and/or from a leaching pile of the invention may also comprise a second mantle, cover or sheet (1, 1′) for the distribution and/or extraction of a flow to and/or from a leaching pile that comprises at least one film or sheet that has a top surface and a bottom surface defining a coverage area defined by the film or sheet, at least one line for conducting, distributing, delivering, withdrawing and/or extracting a flow, such as a solution, water, gas, air, among others, is attached, joined and/or fixed to the bottom surface of the film or sheet, and at least one main alignment and/or extraction pipe for flows, connected to the at least one line for conducting, distributing, delivering, withdrawing and/or extracting a flow, such as a solution, water, gas, air, among others, which has at least one pressure regulation means, and where each of the distribution, delivery and/or extraction lines for flows may also comprise pressure regulation means.

At least one flow sensor is fixed, retained and/or attached to at least one of the double lines (9, 9′), in such a way that said sensor allows measuring the flow conditions of the irrigation pipes (10, 10′), irrigation line (22) and/or gas extraction and/or distribution line (23), individually to transmit and/or control the flow in said pipes through the monitoring, control and/or autonomous remote transmission system, to control and/or remotely monitor the flow conditions conducted through said pipe, this monitoring allows knowing if there is any pipe of at least one double line (9) blocked, such as for example if the irrigation pipe (10) that is originally irrigating the solution over the pile becomes obstructed or blocked, it is replaced in its irrigation by its twin pipe (10′), which allows maintaining a constant and uniform irrigation over time in the leaching pile. In an alternative form, said flow sensors may comprise their own remote transmission and control system and/or autonomous system.

In one embodiment of the invention, the opposite end edges (5, 6) and opposite side edges (7, 8) of the film (2) of the mantle, cover or sheet (1, 1′) for the distribution and/or extraction of a flow to and/or from a leaching pile may comprise joining means, such as for example interlocking joining elements in such a way as to be able to join said film (2) laterally or by its ends to other adjacent films (2), as well as through other joining means, such as a perforated film strip or with eyelets that allows mechanically joining the edges of the sheet or film to the surface of the leaching pile, as well as said lateral and end edges of the film or sheet may have a greater thickness to be able to fix fastening means to join the film between them, or also to the surface of the leaching pile. Additionally, the opposite end edges (5, 6) and opposite side edges (7, 8) of the film (2) of the mantle, cover or sheet (1, 1′) for the distribution and/or extraction of a flow to and/or from a leaching pile may comprise ballast pockets, which may be empty inside, or may have hoses, bags or others disposed therein, where said pockets may comprise connectors to be filled, in such a way as to provide weight to the film or sheet (2).

In another embodiment of the invention, an additional film is disposed, fixed, joined or placed over the device (1, 2′) for leaching the slopes of a leaching pile, in such a way as to cover the entire surface that covers the at least one film or sheet (2, 25) that comprises said device when it is disposed or covering the pile, and where said configuration of the device (1, 1′) may comprise two sheets of film (2, 25), one disposed over the other and joined together, in such a way that said second film is disposed with the object of further improving the impermeability of the device, to better retain the gases below the surface that covers the device, and improve the extraction of gases, thus preventing them from emanating into the environment.

The configuration of the mantle, cover or sheet (1, 1′) for the distribution and/or extraction of a flow to and/or from a leaching pile of the present invention allows reducing the installation time of the irrigation and/or extraction and/or gas distribution system with coverage by approximately 66% compared to the systems traditionally used in the art, where first the irrigation mesh is disposed over the leaching pile, then a cover, and subsequently a control and monitoring system, which translates into the use of a large amount of labor, as well as a longer time required in each installation stage, where it is also not possible to maintain uniformity in the distribution of the irrigation lines, as well as in the distribution of the control and monitoring elements of the leaching pile. The fact that the mantle, cover or sheet (1, 1′) for the distribution and/or extraction of a flow to and/or from a leaching pile of the present invention comprises in an integrated manner an irrigation or watering system and/or gas extraction and/or distribution system allows providing a device for leaching piles that is simpler to install and more efficient.

Through the pattern of holes associated with the drippers of the leaching solution, it is possible to conduct and distribute the leaching solution much more efficiently and homogeneously, where at the same time the film allows producing a greenhouse effect in the leaching pile, generating greater reproduction of bacterial flora, thus reducing the cycles of the process, increasing the temperature compared to the conventional leaching system, decreasing the evaporation rate of the leaching solution and water, thereby reducing the amount of water used, as well as leaching solution, decreasing production costs and thus making the leaching system more efficient.

In tests conducted, the results indicated above have been measured, so for example the temperature inside the covered pile at different depths increases by 5 to 6 degrees compared to the leaching pile without coverage, where the evaporation rate in the uncovered leaching pile was on average 10.8 L/day/m2 and the evaporation rate of the leaching pile with the cover of the present invention was on average 0.42 L/day/m2, which means a 90% savings in water and leaching solution due to evaporation. The fact that the drippers, which comprise the irrigation or watering line of the irrigation mesh of the leaching pile that is connected to the film, allows avoiding the action of the wind on the surface of the pile, which produces a decrease in the sulfatation of the drippers, thus maintaining uniformity of the watering, and which is also achieved by the shape and homogeneous distribution of the irrigation system that is achieved by the arrangement of the cover with the associated irrigation system.

The fact that the cover comprises in a unitary form a protective film, an irrigation mesh, a gas extraction and/or distribution mesh, and sensors associated with the irrigation mesh and/or gas extraction, allows providing a coverage that increases the temperature of a leaching pile thus improving the leaching process and mineral recovery, increasing the moisture of the pile, decreasing the amount of leaching solution used as well as the amount of water used in the process, avoiding sulfatation of the irrigation system, decreasing environmental contamination, increasing the homogeneity of irrigation, and decreasing the installation time of an irrigation mesh and coverage of a leaching pile, as well as achieving online monitoring of the behavior of the leaching pile, and the leaching process and system, in order to react in real time and remotely to correct errors, and thus maximize results, thereby maintaining a constant and uniform irrigation of the solution in the pile.

Although the form of the mantle, cover or sheet (1, 1′) for the distribution and/or extraction of a flow to and/or from a leaching pile described here constitutes a preferred inclusion of this invention, it should be understood that the invention is not limited to this precise form of the mantle, cover or sheet (1, 1′) for the distribution and/or extraction of a flow to and/or from a leaching pile, and that changes can be made to it without departing from the scope of the invention, which is defined in the attached claims.

1. Mantle, cover or sheet (1, 1′) for the distribution and/or extraction of a flow to and/or from a leaching pile that is covering, whose configuration allows maintaining a constant and uniform distribution and/or extraction of flow, comprises at least one film or sheet (2), and at least one irrigation line of solutions or fluids attached, joined and/or fixed to a surface of the film or sheet (2), CHARACTERIZED in that the irrigation line is at least one double irrigation line (9) that comprises at least two irrigation pipes (10, 10′), wherein each of said irrigation pipes (10, 10′) comprises at least one irrigation means, and wherein it also comprises at least one double feed line (11) of fluids or solutions, which comprises two feed pipes (12, 12′), comprising valves and independent flow control means, and wherein said feed pipes (12, 12′) feed the solutions or fluids to the at least one double irrigation line (9), in such a way that the first irrigation pipe (10) is connected to the first feed pipe (12), and the second irrigation pipe (10′) is connected to the second feed pipe (12).

2. Mantle, cover or sheet (1, 1′) for the distribution and/or extraction of a flow to and/or from a leaching pile that is covering, according to claim 1, CHARACTERIZED in that the film or sheet (2) has a top surface (3) and a bottom surface (4) that define an area circumscribed by opposite end edges (5, 6) and opposite side edges (7, 8).

3. Mantle, cover or sheet (1, 1′) for the distribution and/or extraction of a flow to and/or from a leaching pile that is covering, according to claim 1, CHARACTERIZED in that each of said irrigation pipes (10, 10′) comprises at least one irrigation means, wherein said irrigation means is arranged in a spaced distribution along the irrigation pipe (10, 10′), wherein said irrigation means may comprise a sprinkler, a dripper, a micro-sprinkler, or any other fluid distribution means, water, solutions, among others.

4. Mantle, cover or sheet (1, 1′) for the distribution and/or extraction of a flow to and/or from a leaching pile that is covering, according to claim 1, CHARACTERIZED in that it is configured as at least one mantle, cover or sheet (1′) for the distribution and/or extraction of an irrigation flow and/or gases to and/or from a leaching pile, wherein the at least one double line (9′) that is attached and/or fixed to at least one surface (3, 4) of the film or sheet (2) is configured with at least one irrigation line (22) and/or with at least one gas extraction and/or distribution line (23), wherein said irrigation line (22) is connected to a leaching solution feed line (24) that comprises at least one feed pipe that conducts a fluid to said irrigation line (22), and wherein the at least one gas extraction and/or distribution line (23) is connected to a gas extraction and/or feed line (25) that at one of its ends is fixed to a gas extraction or injection means (26), and wherein the leaching solution feed line (24) and the gas extraction and/or feed line

(25) which at one of its ends is fixed to a gas extraction or injection means (26), are arranged or configured at opposite ends of the film or sheet (2).

5. Mantle, cover or sheet (1, 1′) for the distribution and/or extraction of a flow to and/or from a leaching pile that is covering, according to claim 1, CHARACTERIZED in that the double irrigation line (9, 9′) is attached, joined and/or fixed to at least one surface (3, 4) of the film or sheet (2) by at least one fastening and/or joining element (13), which is configured as a strip, tape and/or band (14) of a sheet or film, which comprises a top and bottom surface (15, 16) defined by opposite end edges (17, 18) and opposite side edges (19, 20), which define an area or surface of different dimensions, and wherein said strip, band and/or tape (14) comprises at least one perforation (21) that forms a strip with a predefined perforation pattern.

6. Mantle, cover or sheet (1, 1′) for the distribution and/or extraction of a flow to and/or from a leaching pile that is covering, according to claim 1, CHARACTERIZED in that it comprises a plurality of double lines (9, 9′) that are joined, attached and/or fixed to the surface of the film or sheet (2), in a spaced and parallel manner according to a predetermined pattern, and wherein said double lines (9, 9′) are arranged between said band, tape and/or strip (14) and the at least one surface of the film (2), wherein the lateral portions of said tape, band and/or strip (14) are fixed and/or joined to the at least one surface of the film or sheet (2), so that said double lines (9, 9′) are positioned in between.

7. Mantle, cover or sheet (1, 1′) for the distribution and/or extraction of a flow to and/or from a leaching pile that is covering, according to claim 1, CHARACTERIZED in that it further comprises sensors that can measure and/or monitor temperature, humidity, air flow, luminosity, radiation, evaporation, surface saturation, aeration, among other parameters, as well as said sensors may comprise micro-cameras for capturing images, infrared images, among others.

8. Mantle, cover or sheet (1, 1′) for the distribution and/or extraction of a flow to and/or from a leaching pile that is covering, according to claim 1, CHARACTERIZED in that it further comprises at least one geotextile, a geo net, a mulch joined and/or fixed to one of the top and/or bottom surfaces of the film or sheet (2), covering the entire extent, size and/or shape of said film, as well as it may partially cover the extent.

9. Mantle, cover or sheet (1, 1′) for the distribution and/or extraction of a flow to and/or from a leaching pile that is covering, according to claim 1, CHARACTERIZED in that the opposite end edges (5, 6) and opposite side edges (7, 8) of the film (2) also comprise joining means, such as for example interlocking joining elements, to join said film (2) laterally or by its ends to other adjacent films (2), said joining means may comprise a strip of perforated film or with eyelets to mechanically join the edges of the sheet or film to the surface of the leaching pile, as well as said lateral and end edges of the film or sheet may have a greater thickness to be able to fix fastening means to join the film between them, or also to the surface of the leaching pile, additionally, the opposite end edges (5, 6) and opposite side edges (7, 8) of the film (2) may comprise ballast pockets, which may be empty inside, or may have hoses, bags or others disposed therein, wherein said pockets may comprise connectors to be filled, in such a way as to provide weight to the film or sheet (2).

10. Mantle, cover or sheet (1, 1′) for the distribution and/or extraction of a flow to and/or from a leaching pile that is covering, according to claim 1, CHARACTERIZED in that it further comprises an additional film that is disposed, fixed, joined or placed over the device (1, 1′) for leaching a leaching pile, in such a way as to cover the entire surface that covers the at least one film or sheet (2) when it is disposed or covering the pile, and wherein said configuration may comprise two sheets of film (2), one disposed over the other and joined together.
